(19) United States
(12) Patent Application Publication
(10) Pub. No.: US 2006/0149494 A1
(43) Pub. Date: Jul. 6, 2006

(54) Monitoring of shock absorbers

(76) Inventors: Frederik Petrus Venter, Brits (ZA); Michael Jacobus Venter, Pretoria (ZA); Hermanus Nicolaas Venter, Brits (ZA); Johanna Frederika Bresler, Ellisras (ZA)

Correspondence Address: Brinks Hofer;Gilson & Lione, PO Box 10438, Chicago, IL, 60611-5599, US

(21) Appl. No.: 10/536,536

(22) PCT Filed: Nov. 25, 2003
(86) PCT No.: PCT/IB03/05388

§ 371 Date: Oct. 13, 2005

(30) Foreign Application Priority Data
Nov. 26, 2002 (ZA) 2002/9607

(51) Int. Cl. G01P 15/00

(52) U.S. Cl. 702/141

(57) ABSTRACT

A method of determining the damping factor of a shock absorber includes attaching an accelerometer to one of a first and a second part of the shock absorber. The first- and second parts are displaced relative to one another at least once and the acceleration of the parts relative to each other is measured by reading a signal from the accelerometer. The damping factor is then determined by analysis of the measured acceleration. A shock absorber monitoring system for use in the method includes an accelerometer for generating an acceleration signal. A processor is connected to the accelerometer and reads the acceleration signal from the accelerometer thereby to calculate a damping factor of the shock absorber when the first- and second parts of the shock absorber are displaced relative to one another. An indicator, responsive to the processor, displays a value representative of the damping factor of the shock absorber.

THIS INVENTION relates to the monitoring of shock absorbers, particularly, but not exclusively, for use on, or fitted to, a vehicle suspension.

In accordance with the invention, a method of determining the damping factor of a shock absorber includes

attaching an accelerometer to one of a first and a second part of the shock absorber;

displacing the first- and second parts of the shock absorber relative to one another at least once;

measuring the acceleration of the parts of the shock absorber relative to each other by reading a signal from the accelerometer; and

determining the damping factor of the shock absorber by analysis of the measured acceleration.

Further in accordance with the invention, there is provided a shock absorber monitoring system, which includes

an accelerometer for generating an acceleration signal, the accelerometer being removably attachable to one of a first part and a second part of a shock absorber;

a processor connected to the accelerometer, the processor being operable to read the acceleration signal from the accelerometer and to calculate a damping factor of the shock absorber when the first- and second parts of the shock absorber are displaced relative to one another, and

an indicator responsive to the processor, operable to display a value representative of the damping factor of the shock absorber.

The shock absorber may be monitored as a unit removed from a vehicle, or it may be monitored while it is fixed to a suspension of a vehicle. The method may then include attaching the accelerometer to a vehicle body which is fast with one of the first part and the second part of the shock absorber, in a position proximate the shock absorber to be monitored, for example, proximate one of the wheels of the vehicle, thereby to determine the damping factor of the shock absorber at the wheel and thereby limiting the effect of the shock absorbers at other wheels of the vehicle.

The accelerometer may include attachment means, to permit removable attachment to the vehicle body, or to one part of the shock absorber. The attachment means may, for example, include a magnetic coupling device, a suction cup, or the like.

The signal from the accelerometer may be read over a period of time, and at discrete intervals, to generate a series of measured acceleration values.

The method of determining the damping factor of the shock absorber may include modeling the movement properties of the shock absorber mathematically with a differential equation, e.g. a second order differential equation, to generate a series of theoretical acceleration values and mathematically fitting the series of theoretical acceleration values to the series of measured acceleration values.

The method may include mathematically solving the differential equation in a time domain, thereby to obtain a theoretical solution to a series of theoretical position values over the period of time.

The method may include mathematically fitting the series of theoretical acceleration values to the series of measured acceleration values in an iterative manner.

The iterative fitting of the series of theoretical acceleration values to the series of measured acceleration values may be repeated until a predefined correlation between the series of theoretical- and measured acceleration values is obtained.

The mathematical fitting of the series of theoretical acceleration values to the series of measured acceleration values may employ a “Nelder Mead” algorithm.

The method may include generating a damping constant from the fitted series of theoretical acceleration values from the mathematical model, thereby to approximate the damping factor of the shock absorber with the damping constant and may include comparing the approximated damping factor of the shock absorber with qualitative data from a manufacturer of the shock absorber.

The method may include generating an alarm when the approximated damping factor falls outside tolerable limits of the qualitative data or if displacement of the parts of the shock absorber is insufficient or excessive.

The method may be repeated a plurality of times and the damping factors thereby obtained may be stored to permit the average of the stored damping factors to be calculated.

Hence, the shock absorber monitoring system may include a storage device to store the damping factors. The storage device, or another storage device, may store a set of instructions, which instructions, when executed by the processor, direct the processor to perform the mathematical calculations as herein described.

The accelerometer may be remote from the processor.

In one embodiment, the shock absorber monitoring system may include an output buffer which is electrically connected to the accelerometer and may include an input buffer, which is electrically connected to the processor. The output buffer and the input buffer may then be connected by means of an electrical cable.

In another embodiment, the accelerometer may include a radio frequency transmitter and the processor may include a radio frequency receiver responsive to the transmitter, operable to receive the acceleration signal by means of a radio frequency signal.

The shock absorber monitoring system may include a power supply, in use to supply electrical power to any one, or more of the accelerometer, the processor and the indicator.

The shock absorber monitoring system may include a communication port connected to the processor, operable to send and receive data to and from a remote device, such as a personal computer.

The invention will now be described, by way of example only, with reference to the following drawings, in which:

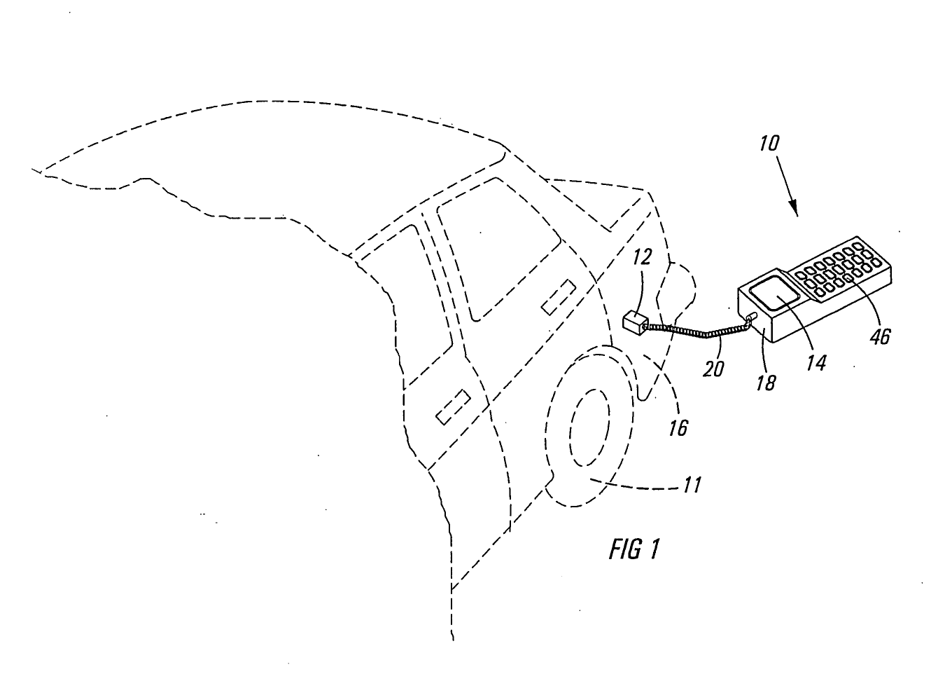

FIG. 1 shows a three dimensional view of a shock absorber monitoring system in accordance with the invention, in use;

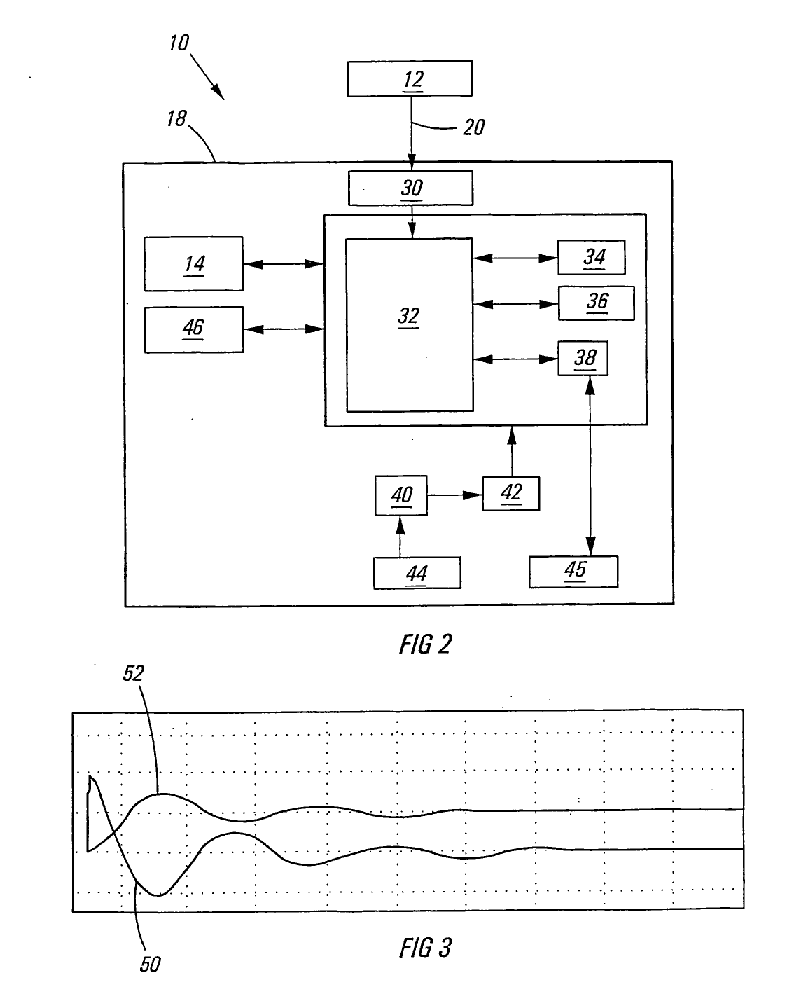

FIG. 2 shows a schematic block diagram of a shock absorber monitoring system in accordance with the invention;

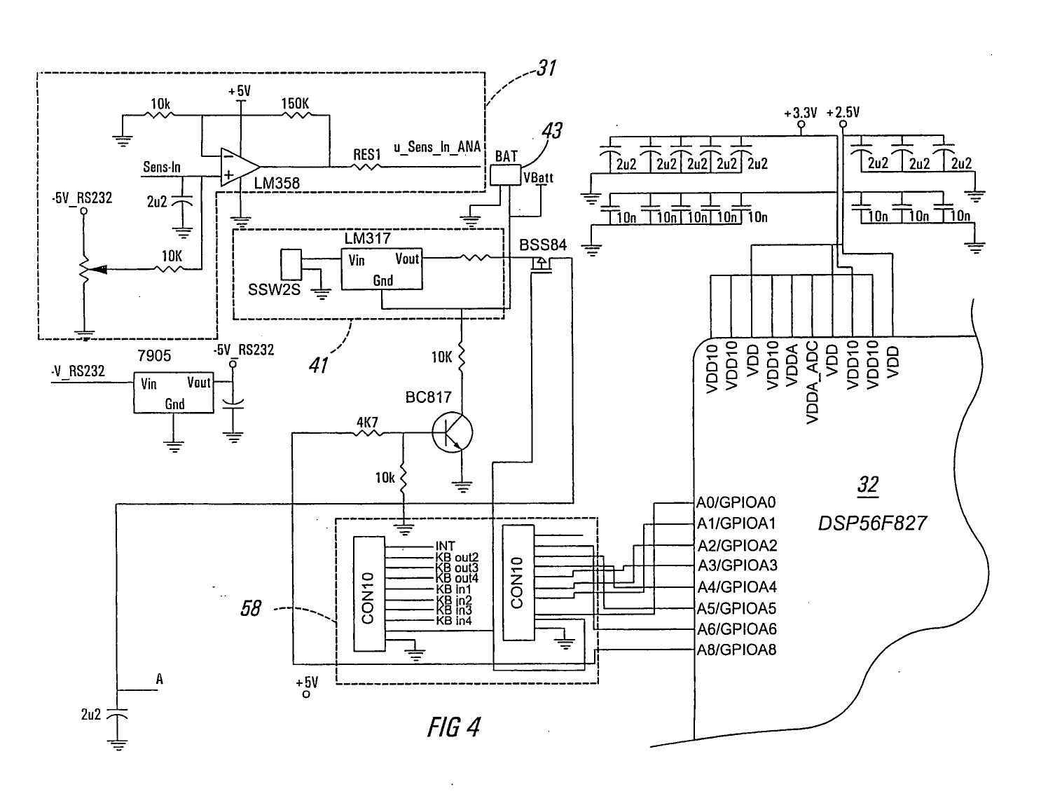

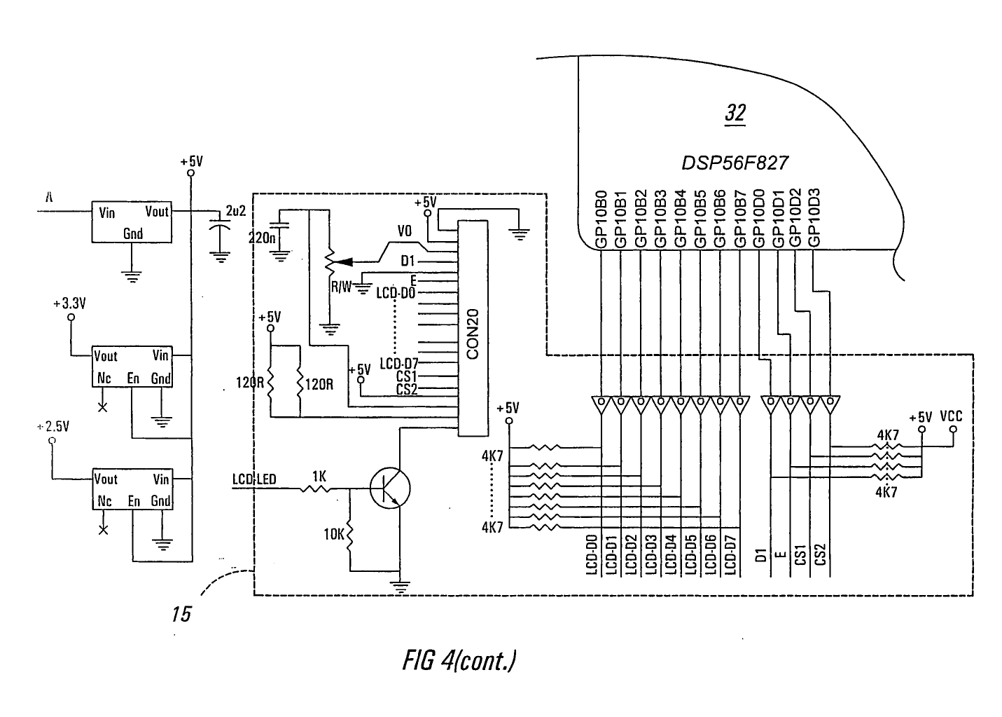

FIG. 3 shows a graph of a series of acceleration values plotted over time; and

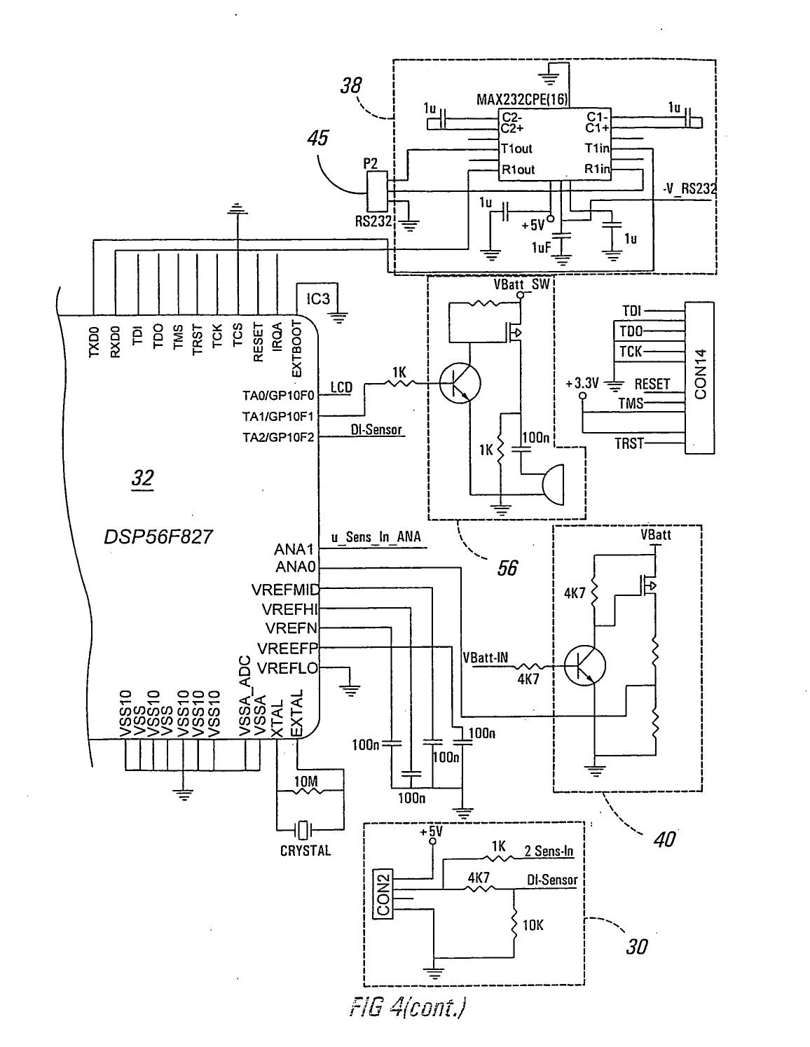

FIG. 4 shows a schematic circuit diagram of part of the shock absorber monitoring system of FIG. 2.

In the drawings, reference numeral 10 generally indicates a shock absorber monitoring system. The shock absorber monitoring system 10 includes an accelerometer 12, a handheld housing 18 and a coiled electrical cable 20 connecting the accelerometer 12 and the handheld housing 18.

In this example the accelerometer is an ADXL202AE device manufactured by Analog Devices. The accelerometer is a dual-axis accelerometer, of which only one axis is used to determine the damping factor of a vehicle shock absorber.

An indicator 14 in the form of a liquid crystal display (LCD) and a membrane keypad 46 are provided on the handheld housing 18. The shock absorber monitoring system 10 also includes a buzzer 56 (see FIG. 4) which gives audio signals to a user during use of the shock absorber monitoring system 10. The shock absorber monitoring system 10 is used to monitor a suspension (not shown) of a vehicle 16. In use, the accelerometer 12 is mounted proximate a location where the shock absorber (not shown) is installed in the suspension of the vehicle.

The accelerometer 12 has attachment means in the form of a magnetic coupling device (not shown) by which it is removably attached to a metal body of the vehicle 16 so that one of the two axes of the accelerometer is substantially perpendicular to ground level. In another embodiment of the invention, the attachment means may be in the form of a suction cup.

Referring to FIG. 2 and to FIG. 4, the shock absorber monitoring system 10 is shown in a schematic block diagram and in a schematic circuit diagram. The accelerometer 12 includes a unity gain operational amplifier (not shown). The unity gain operational amplifier of the accelerometer 12 is connected to signal conditioning circuitry 30, by means of the coiled electrical cable 20 of FIG. 1. The signal conditioning circuitry 30 is connected to an analog input of a micro processor 32. The signal condition circuitry 30 also includes an operational amplifier wired as a subtractor/amplifier combination and which is tuned to cancel the effect of gravity on the accelerometer and, in addition, to amplify the acceleration signal. The operational amplifiers are both LM358-type devices. The micro processor is a DSP56F827FG80 device available from Motorola.

The shock absorber monitoring system 10 includes a communication interface 38 leading to connector 45. The communication interface is connected to the micro processor 32, and includes an RS232 driver, capable of a data transfer rate of 19200 baud.

The micro processor 32 includes flash random access memory (Flash RAM) 36 for storage of non-volatile data and static random access memory (SRAM) 34 for temporary storage of data and which are schematically shown in FIG. 3 but not in FIG. 4. The micro processor 32 has the capability to perform mathematical calculations as described below.

The shock absorber monitoring system 10 also includes a battery charger 40, connected to connector 44 and to a rechargeable battery 42. Two parts of the battery charger are shown in FIG. 4 by reference numerals 40 and 41. Only a connecter 43 to the battery 42 is shown in FIG. 4. The battery charger regulates the supply voltage to the shock absorber monitoring system 10 to 5 volts and provides an electrical supply to charge the battery which is a 7.2V Nickel-Cadmium battery.

The liquid crystal display (LCD) indicator 14 has a graphic display capability and is connected to the micro processor 32. Only the connector and analog control circuitry 15 are shown in FIG. 4. The LCD display is a 128×64 dots display from Emerging Display Technologies (EDT) with an 8 bit wide data/address bus interface.

The membrane keypad 46 is connected directly to the micro processor 32 for providing a user interface to the micro processor 32. In use, the micro processor 32 reads the inputs from the keypad 46 as 4 rows and 4 columns connected to 8 digital I/o signals via pull-up resistors (not shown). In FIG. 4, only connector 58 to the keypad 46 is shown.

The micro processor 32 has internal processor Flash RAM (not shown) on which executable code, that directs the operation of the micro processor 32, is stored.

The executable code includes commands to read keystrokes from a user via the membrane keypad 46, and includes commands to display information to the user via the indicator 14. Typically the user will be requested to indicate which shock absorber is to be tested (left front, right front, left rear, right rear), the user will also be requested to supply vehicle information, and the results of tests will be displayed on the indicator 14.

In use, the shock absorber monitoring system 10 is switched on and off with a key on the keypad 46, the correct measurement range for the type of shock absorber to be tested is selected on the keypad 46, the accelerometer 12 is attached to the vehicle body 16 and the vehicle body 16 is displaced on its suspension by rapidly pushing down on the body so as to compress the shock absorber in the suspension and then allowing the suspension to settle. As the suspension settles, incidental acceleration values of the vehicle body 16 on the suspension are recorded at discrete time intervals over a period of time, which time is typically the settling period of the suspension. The series of values, when plotted over time, is indicated in the graph in FIG. 3 by reference numeral 50.

A formula 54 (see below) providing a theoretical time-domain solution to the displacement value of a differential equation is also stored in the processor Flash RAM. With properly selected tuning values the formula 54 will produce a range of displacement values that may produce a graph similar to that indicated by reference numeral 52 in FIG. 3. The formula 54 for the time domain solution of the displacement value is as follows:
Y=2(1−(PK/2t)(T/t))Y₁−(T²/t²−2(PK/2t²)+1)Y₀+K(T²/t²)MV (54)
Where

P=damping constant

K=spring constant

t=lag

T=discrete time interval

MV=initial displacement

Y=displacement at time interval (T)

Y₁=displacement in previous time interval (T−1)

Y₀=displacement at time interval (T−2)

Y is differentiated to obtain an acceleration value by the formula:
A=d²y/dt² (60)

A range of theoretical values generated by formula 60 is mathematically fitted to the calculated acceleration values by means of a curve fitting algorithm such as the “Nelder Mead” algorithm. The curve fitting algorithm iteratively adjusts the values for P, K and t until the series of Y values approximate the series of measured displacement values within tolerable limits. It is to be appreciated that any other curve fitting algorithm can be used to fit the range of theoretical displacement values to the calculated range of values. The values for the damping constant (P), the spring constant (K) and the lag (t) are thus determined.

The damping factor (P) is a measure of the effective damping force of the measured shock absorber. Preferably, the procedure is repeated a number of times, e.g. three times, and the average of the best samples presented as a result.

By comparing the damping factor (P) to a previously stored quantitative damping factor from the manufacturer of the shock absorber, the processor 32 calculates whether the damping factor (P) is within tolerable limits of the quantitative damping factor and, if not, generates an alarm.

The result of the calculation is then displayed on the indicator 14. For example, the indicator 14 will display a percentage value of the effectiveness of the shock absorber and will indicate if the shock absorber should be replaced or not. The processor 32 has sufficient memory to store the results of a number of successive shock absorber tests and can download the test results to a PC. The processor 32 is also programmed to give a warning if insufficient or excessive displacement is made to the vehicle during the test.

The Inventor believes that the shock absorber monitoring system 10, as illustrated, provides a system for determining the damping factor of a shock absorber which is accurate and is easily effected by simply attaching the accelerometer 12 to the vehicle and displacing the vehicle downwardly.

1. A method of determining a damping factor of a shock absorber, the method comprising:
attaching an accelerometer to one of a first and a second part of the shock absorber;
displacing the first and second parts of the sock absorber relative to one another at least once;
measuring an acceleration of the first and second parts of the shock absorber relative to each other by reading a signal from the accelerometer; and
determining the damping factor of the shock absorber by analysis of the measured acceleration.

2. The method as claimed in claim 1, further comprising:
attaching the accelerometer to a vehicle body proximate one of the wheels of the vehicle body and which is fast with one of the first part and the second part of the shock absorber.

3. The method as claimed in claim 1, wherein the signal from the accelerometer is read over a period of time at discrete intervals, to generate a series of measured acceleration values.

4. The method as claimed in claim 3, wherein determining the damping factor of the shock absorber comprises modeling movement properties of the shock absorber mathematically with a differential equation to generate a series of theoretical acceleration values and mathematically fitting the series of theoretical acceleration values to the series of measured acceleration values.

5. The method as claimed in claim 4, wherein the differential equation is of the second order.

6. The method as claimed in claim 4, wherein the mathematical fitting of the series of theoretical acceleration values to the series of measured acceleration values is performed iteratively.

7. The method as claimed in claim 6, wherein the iterative fitting of the series of theoretical acceleration values to the series of measured acceleration values is repeated until a predefined correlation between the series of theoretical and measured acceleration values is obtained.

8. The method as claimed in claim 7, wherein the mathematical fitting of the series of theoretical acceleration values to the series of measured acceleration values employs a Nelder Mead” algorithm.

9. The method as claimed in claim 8, wherein a damping constant from the fitted series of theoretical acceleration values is generated from the mathematical model to approximate the damping factor of the shock absorber with the damping constant generated from the mathematical model, and to compare the approximated damping factor of the shock absorber with qualitative data from a manufacturer of the shock absorber.

10. The method as claimed in claim 9, further comprising:
generating an alarm when the approximated damping factor falls outside tolerable limits of the qualitative data.

11. The method as claimed in claim 9, further comprising:
repeating the method a plurality of times;
storing the damping factors thereby obtained; and
calculating an average of the stored damping factors.

12. A shock absorber monitoring system, the system comprising:
an accelerometer to generate an acceleration signal, the accelerometer being removably attachable to one of a first part and a second part of a shock absorber;
a processor connected to the accelerometer, a processor being operable to read the acceleration signal from the accelerometer and to calculate a damping factor of the shock absorber when the first and second parts of the shock absorber are displaced relative to one another; and
an indicator responsive to the process or, operable to display a value representative of the damping factor of the shock absorber.

13. The shock absorber monitoring system a claimed in claim 12, further comprising a storage device in which a set of instructions are stored, which instructions, when executed by the processor, direct the processor to perform a set of mathematical calculations.

14. The shock absorber monitoring system as claimed in claim 12, wherein the accelerometer is remote from the processor.

15. The shock absorber monitoring system claimed in claim 14, wherein the accelerometer includes radio frequency transmitter and the processor includes a radio frequency receiver responsive to the transmitter, operable to receive the acceleration signal via a radio frequency signal.

16. The shock absorber monitoring system as claimed in claim 12, further comprising a communication port connected to the processor, operable to send and receive data to and from a remote device, such as a personal computer.
